(19) United States
(12) Patent Application Publication
(10) Pub. No.: US 2026/0261160 A1
(43) Pub. Date: Sep. 3, 2026

(54) ROTOR SLEEVE BASED ON A THERMOPLASTIC COMPOSITE MATERIAL

(71) Applicant: SYENSQO SPECIALTY POLYMERS USA, LLC, Alpharetta, GA (US)

(72) Inventors: DeeDee Smith, Dacula, GA (US); Nan Chen, Cumming, GA (US); Brian Baleno, Milton, GA (US); Glenn P. Desio, Marietta, GA (US)

(73) Assignee: SYENSQO SPECIALTY POLYMERS USA, LLC, Alpharetta, GA (US)

(21) Appl. No.: 18/878,551

(22) PCT Filed: Jun. 27, 2023
(86) PCT No.: PCT/EP2023/067499

§ 371 Date: Dec. 23, 2024

Related U.S. Application Data
(60) Provisional application No. 63/355,693, filed on Jun. 27, 2022.

(30) Foreign Application Priority Data
Oct. 8, 2022 (EP) 22200446.7

(51) Int. Cl. H02K 1/04; C08J 5/24; H02K 1/278; H02K 1/28; H02K 15/10

(52) U.S. Cl. CPC H02K 1/04; C08J 5/243; H02K 1/278; H02K 1/28; H02K 15/10; C08J 2371/10

(57) ABSTRACT

The invention relates to a rotor sleeve made of or comprising a thermoplastic composite (TPC) which comprises or consists of: (1) a polymer matrix (P); and (2) continuous fibers; wherein the polymer matrix (P) comprises or consists of: •at least one thermoplastic polymer having a Tg higher than 90° C. and selected in the group consisting of a polyaryletherketone (PAEK), a polyphthalamide (PPA), a polyamide-imide (PAI), a polyphenylene sulfide (PPS) and blends of two or more of said polymers; •optionally at least one plastic additive; and wherein the continuous fibers are selected in the group consisting of •continuous carbon fibers (CF), and •continuous glass fibers (GF).

This application claims priority of European patent application No. 22200446.7 filed on 16 Jun. 2022, the content of which being entirely incorporated herein by reference for all purposes. In case of any incoherency between the two applications that would affect the clarity of a term or expression, it should be made reference to the present application only.

### TECHNICAL FIELD

This present invention pertains to a rotor sleeve based on a thermoplastic composite material and to an electrical machine or rotor comprising said rotor sleeve.

### BACKGROUND ART AND TECHNICAL PROBLEM TO BE SOLVED

The trend towards designing and building fuel efficient, low or zero emission on-road and off-road vehicles has increased dramatically in recent years, with significant emphasis being placed on the development of hybrid and all-electric vehicles. This has led, in turn, to a greater emphasis being placed on electric motors, either as the sole source of propulsion (e.g., all-electric vehicles) or as a secondary source of propulsion in a combined propulsion system (e.g., hybrid or dual electric motor vehicles).

The electric motors in such an application may utilize either an AC or DC permanent magnet motor design or an AC induction motor design. Regardless of the type of electric motor, motors are generally designed for a particular application to achieve the desired efficiency, torque density, or high speed power with an acceptable motor size and weight. Increasing the spin speed of the electric motor is widely believed to be one of the most attractive ways to improve power density to increase efficiency and, therefore, the range of electric vehicles without increasing the size, cost, and mass of the battery pack. By increasing the speed of the rotor, the parts of a spinning rotor can be exposed to extreme centripetal forces. If the parts are not properly held in place, they can lift off even slightly from the rotor, which can result in failure of the motor. A known solution to this challenge was addressed by the use around the rotor of a rotor sleeve. A rotor sleeve is a component which is disposed around the rotor. Its function is to mechanically retain the components, and more specifically the permanent magnets, of the rotor and to ensure the rotor integrity, independently of the working conditions, i.e. rotation speed, temperature (which can varies from −40° C. up to +150° C.), humidity, presence of fluids. This sleeve can be made of metallic or composite materials. The most commonly used composite materials are those based on thermoset matrixes. WO 2020/188006 (Safran) discloses a fibre-reinforced composite sleeve in a generator. WO 2021/225902 (Tesla) discloses a rotor wrapped with a wound fiber sleeve.

US 2022/278584 (D1) discloses a rotor sleeve for a rotor of an electric machine, the rotor sleeve defining a rotational axis and comprising: a plurality of layers of carbon fibre reinforced polymer, each layer comprising fibres oriented substantially 90° to the rotational axis; at least one layer of fibres having a lower modulus of elasticity provided between layers of carbon fibre reinforced polymer, wherein the lower modulus of elasticity fibres are oriented between 50° and 75° relative to the rotational axis (X).

U.S. Pat. No. 5,275,883 (D2) discloses a flexible composite material comprised of a sheath surrounding a core consisting essentially of continuous fibers the fiber being coated with a mixture of a polymer powder which is transformable by a rise in temperature to form links with said fibers and said sheath. WO 2021/259757 (D3) discloses a method for making a carbon fiber reinforced poly(aryletherketone) composition. WO 2022152653 (D4) discloses an assembly comprising a film of PEEK-PEoEK. These documents D2-D4 are unrelated to rotor sleeve and do not disclose a rotor sleeve.

The preparation of a sleeve based on a thermoset composite material around the rotor requires a specific lengthy, and in certain casis dirty (i.e. wet winding) process. There is therefore the need of a rotor sleeve that can be more easily prepared. Moreover, because of today's growing importance of a circular economy, there is also a need of a rotor sleeve that can be totally or partly recycled.

The rotor sleeve needs to have the right combination of properties, even at low thickness, such as a low eddy current loss, a high strength and a good thermal resistance to the low and high temperatures that are generated by the electric currents and the mechanical forces. Resistance to wear, fatigue and chemicals are also required as well as elasticity or toughness when the rotor is assembled by press-fitting. The rotor sleeve should also provide pre-pressure for the permanent magnet to ensure that the rotor parts are not separated during operation.

The rotor sleeve should also exhibit a high NOL strength as measured according to ASTM D2290.

The rotor sleeve of the present invention aims at solving this technical problem.

### BRIEF DISCLOSURE OF THE INVENTION

The invention is set out in the appended set of claims.

The invention relates to a rotor sleeve as defined in claims 1-19.

The invention also relates to a method of preparation of the rotor sleeve as defined in claims 20-27.

The invention also relates to an electrical machine as defined in claim 28.

The invention also relates to a rotor as defined in claim 29.

The invention also relates to the use as defined in any one of claims 30-32.

The invention also relates to a tape as defined herein for the preparation of rotor sleeve, notably a rotor sleeve as defined herein and in the claims.

These subject-matters are now defined in more details below.

### FIGURES

FIG. 1 illustrates a rotor sleeve according to the invention. FIG. 1 represents a rotor around which a rotor sleeve is disposed.

FIG. 2 represents a rotor sleeve separated from the rotor.

FIG. 3 illustrates the method (M1) where a tape is winded (hoop winding) around a rotating mandrel. W is the width of the tape, D is the diameter of the mandrel and L=π D. Angle α is defined by relation: sin α=W/L.

FIG. 4 illustrates with more details the method (M1) where a tape is winded around a rotating mandrel and a laser is used to heat locally the tape. (1): tape; (2) contact pressure roller; (3): laser; (4): mandrel.

FIG. 5 illustrates with more details the method (M1) where a tape is winded around a rotating mandrel and a heat source is used to heat locally the tape. (1): heat source; (2): incoming tape; (3): heat flow; (4) pressure roller; (5) nip point; (6) tape already stacked; (7): surface of the mandrel; (8): the arrows represents the tensioning of the tape during winding.

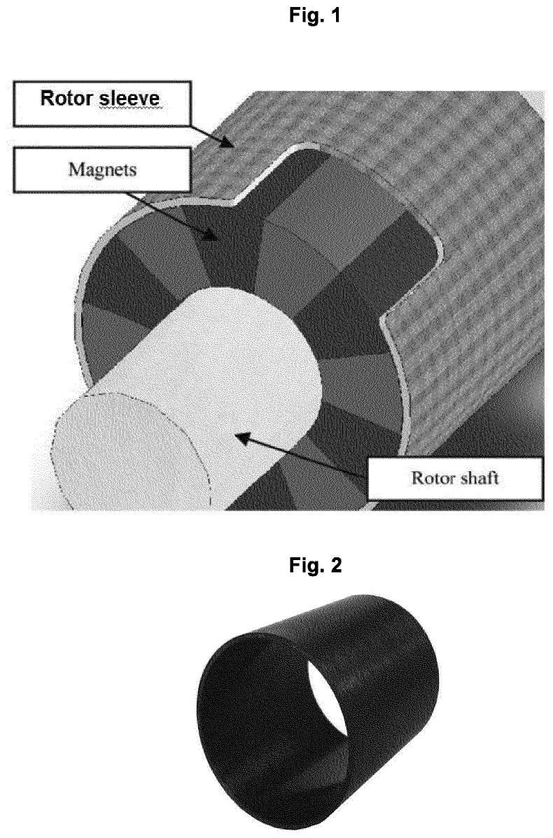

### GENERAL DEFINITIONS

Unless otherwise indicated, the percentages are given by weight (wt. %). As is common practice in the field, it must be added that the content of fiber can also be expressed in percentage by volume (vol. %) and calculated according to the following equation:

$$\\ content of fiber ( \% ) = \frac{Volume of fiber}{Volume of fiber + Volume of polymer} \times 100$$

The proportion of recurring units in a polymer are given in mol. % relative to the total number of moles of recurring units in the polymer.

When numerical ranges are indicated, range ends are included.

The expression “rotor sleeve” is generally used to identify a tubular hollow part designed to fit around the rotor of an electrical machine.

Tg designates the glass temperature. It is conveniently measured by Differential Scanning calorimeter (DSC) according to ASTM D3418.

Tm and Hm designate respectively the melting temperature and the heat of fusion. They are conveniently measured by DSC according to ASTM D3418. It is noted that the crystallinity of the tape or of the thermoplastic composite of the rotor sleeve is measured on the 1^{st} ramp-up (e.g. see experimental section).

### DISCLOSURE OF THE INVENTION

The invention relates to a rotor sleeve made of or comprising a thermoplastic composite (TPC) as defined herein. The TPC comprises or consists of (1) a polymer matrix (P) as defined herein; and (2) continuous fibers as defined herein.

Typically, the rotor sleeve is hollow and substantially cylindrical. Its cross-section is generally round.

The thickness of the rotor sleeve is generally between 0.1 and 20.0 mm, preferably between 0.1 and 5.0 mm, preferably between 0.1 and 3.0 mm, preferably between 0.1 and 2.0 mm. The thickness of the rotor sleeve is preferably between 0.5 and 2.0 mm.

The diameter of a rotor sleeve with a substantially round cross-section is generally between 20.0 mm and 500.0 mm. Larger diameters exist notably having a diameter up to and 10.0 m.

The invention also relates to an electrical machine, such as a motor or a generator, including:
a stator;
a rotor disposed within the stator and configured to rotate relative to the stator;
   wherein the rotor sleeve as disclosed herein is disposed circumferentially around the rotor.

The invention also relates to a rotor of an electrical machine such as a motor or a generator wherein the rotor sleeve of the invention is disposed circumferentially around the magnets.

The invention also relates to the use of a thermoplastic composite material (TPC) as defined herein for the preparation of a rotor sleeve.

The thermoplastic composite material (TPC) comprises or consists of:
(1) a polymer matrix (P); and
(2) continuous fibers;
   wherein the polymer matrix (P) comprises or consists of:
      at least one thermoplastic polymer having a Tg higher than 90° C. and selected in the group consisting of a polyaryletherketone (PAEK), a polyphthalamide (PPA), a polyamide-imide (PAI), a polyphenylene sulfide (PPS) and blends of two or more of said polymers;
      optionally at least one plastic additive; and
   wherein the continuous fibers are selected in the group consisting of
      continuous carbon fibers (CF), and
      continuous glass fibers (GF).

The continuous fibers are embedded in and in contact with the polymer matrix (P). The function of the continuous fibers is to reinforce the polymer matrix (P).

According to an embodiment, the polymeric matrix (P) consists essentially or consists of at least one thermoplastic polymer as defined herein and optionally at least one plastic additive.

The proportion of the continuous fibers in the thermoplastic composite (TPC) is generally between 30.0 and 80.0 wt. %, this proportion being based on the total weight of the thermoplastic composite (TPC). The proportion of the polymer matrix (P) in the thermoplastic composite (TPC) is generally between 20.0 and 70.0 wt. %, this proportion being based on the total weight of the thermoplastic composite (TPC).

The proportion of fibers is preferably at least 130.0 g/m². This proportion may be between 130.0 and 160.0 g/m².

The thermoplastic polymer or the blend of thermoplastic polymers in the thermoplastic composite (TPC) is preferably semi-crystalline.

The continuous fiber is typically in the form of a tow.

The thermoplastic polymer or the blend of thermoplastic polymers preferably exhibits a heat of fusion (Hm) which is at least 5.0 J/g, more preferably at least 10.0 J/g or at least 15.0 J/g. The heat of fusion (Hm) is determined by DSC. More particularly, the heat of fusion is determined as the area under the melting endotherm on the second heat scan.

The thermoplastic polymer preferably exhibits a melting temperature (Tm) of at least 250° C., preferably at least 300° C. Tm is determined by DSC. More particularly, Tm is determined on the second heat scan.

Preferred embodiment (E): according to a preferred embodiment (E), the thermoplastic polymer in the polymer matrix (P) is a polyaryletherketone (PAEK) or a blend of more than one PAEK. According to this embodiment (E), the thermoplastic polymer typically exhibits a Tg of at least 140° C.

According to the invention and to embodiment (E), the thermoplastic polymer is selected in the group consisting of poly(ether ether ketone) (PEEK), poly(ether ketone ketone) (PEKK), poly(ether ketone) (PEK), poly(ether ether ketone ketone) (PEEKK), PEDEKK, PEEK-PEDEK, PEEK-PEOEK and blends of two or more of said polymers.

Thus, the thermoplastic composite (TPC) more particularly comprises or consists of:
(1) a polymer matrix (P); and
(2) continuous fibers,
   wherein the polymer matrix (P) comprises or consists of:
      at least one thermoplastic polymer is selected in the group consisting of poly(ether ether ketone) (PEEK), poly(ether ketone ketone) (PEKK), poly(ether ketone) (PEK), poly(ether ether ketone ketone) (PEEKK), PEDEKK, PEEK-PEDEK, PEEK-PEOEK and blends of two or more of said polymers.
      optionally at least one plastic additive;
   wherein the continuous fibers are selected in the group consisting of
      continuous carbon fibers (CF), and
      continuous glass fibers (GF).

According to the invention and to the embodiment (E), the thermoplastic polymer may more particularly be a PEEK or a blend of at least one PEEK and at least one thermoplastic polymer other than the PEEK and selected in the group consisting of poly(ether ketone ketone) (PEKK), poly(ether ketone) (PEK), poly(ether ether ketone ketone) (PEEKK), PEDEKK, PEEK-PEDEK and PEEK-PEOEK. The relative proportion by weight of PEEK(s)/thermoplastic polymer(s) other than PEEK in the blend may be between 50/50 and 99/1.

The thermoplastic polymer of the polymer matrix (P) may any one of the PAEKs disclosed in this list. The thermoplastic polymer of the polymer matrix (P) is preferably a PEEK.

Details and embodiments on the thermoplastic polymers that can be used in the thermoplastic composite (TC) are given below.

The continuous fibers are preferably continuous carbon fibers.

Preparation of the rotor sleeve: the rotor sleeve may be prepared according to two methods (M1) and (M2). In both methods, the rotor sleeve is prepared by winding a tape of the thermoplastic composite (TPC).

### Method (M1): Assembly by Press-Fitting

The rotor sleeve may be prepared by a method (M1) comprising the following steps:
step a): winding a tape of a thermoplastic composite (TPC) over a rotating mandrel to form a plurality of layers of the thermoplastic composite (TPC) around the mandrel;
step b): separating the formed rotor-sleeve from the mandrel.

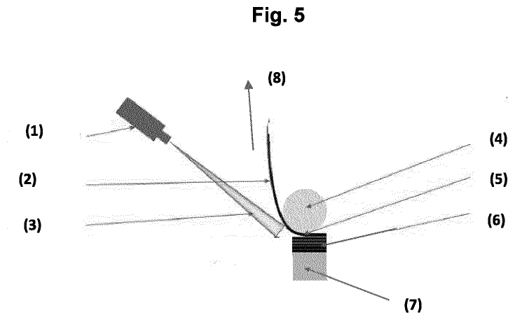

In step a), a tape is winded around a rotating mandrel. The diameter of the mandrel corresponds substantially to the inner diameter of the rotor sleeve. The tape is melted near the nip point (i.e. where the incoming tape is in contact with the previous ply) by a specific heat source to allow a subsequent consolidation (see FIG. 5). At the nip point, the tape is heated at a temperature sufficient to melt the polymer matrix (P) of the TPC. T is generally greater than or equal to (≥) Tm+20° C., where Tm is the melting temperature of the thermoplastic polymer. If the matrix comprises m thermoplastic polymers, Tm is the melting temperature of the thermoplastic polymer having the highest Tm. The heat source can be a hot gas torch, a laser or a source of infrared. The temperature is generally measured continuously by a pyrometer or an infra-red camera to control the heat source. At the same time, a roller, which can be made of metallic or non-metallic (typically a silicone) material, compresses the whole piece in order to create an intimate contact between the plies. The pressing force really applied on the part is a combination between the tensile force applied on the incoming tape and the pressure ensure by the roller against the stacking. The pressing force and the tensile force applied to the tape are controlled by a combination of force sensors. The same procedure is repeated until the desired number of plies is stacked to make the rotor sleeve with the required thickness. Combination of temperature and pressure ensures the in-situ consolidation of the composite part without requiring further consolidation steps. The laser winding process is illustrated in FIG. 4.

After removing the formed sleeve from the mandrel, it can be machined and trimmed in order to make sleeves with the required length and surface roughness (Ra). Once finished, the rotor sleeve can be press-fitted around the rotor. The goal of press-fitting is to provide enough radial compressive stress to compensate the high centrifugal force generated by the spinning of the rotor to allow the motor to achieve a high speed and a high power level. The compressive stresses are resulting here from interference fits between the permanent magnets and the sleeves.

### Method (M2): Direct Winding

The rotor sleeve may also be prepared by another more direct method (M2) which comprises the step of winding a tape of the thermoplastic composite (TPC) over the rotor to form a plurality of layers of the thermoplastic composite (TPC) around the rotor.

As for method (M1), the tape is heated at a temperature T sufficient to melt the polymer matrix (P) of the TPC. T is generally greater than or equal to (2) Tm+20° C., where Tm is the melting temperature of the thermoplastic polymer. If the matrix comprises several thermoplastic polymers, Tm corresponds to the melting temperature of the thermoplastic polymer having the highest Tm. The source of heat is the same as disclosed above for method (M1).

In process (M2), the several layers of the sleeve are overwound directly onto the permanent magnet rotor. This process is characterized by a ultra-high tension applied to the incoming tape. This pre-tension is a key parameter to provide enough compressive stress to counteract the large centrifugal force and to ensure permanent magnets are retained on the rotor spindle. The maximum tension of the carbon fibers is obtained by applying huge winding tension. This pre-tension creates a hoop stress that acts as a compressive stress, keeping the in-situ consolidated thermoplastic composite sleeve in place over the permanent magnet rotor.

For both methods, the fibers can be winded around the mandrel or around the rotor according to a predetermined pattern such as hoop winding or crossed winding.

In method (M2), a tension (aka as pretension) is generally applied on the fibers prior to winding. This makes it possible to obtain a rotor sleeve that exhibits enough radial compressive stress to compensate for the high centrifugal forces during the rotation of the rotor.

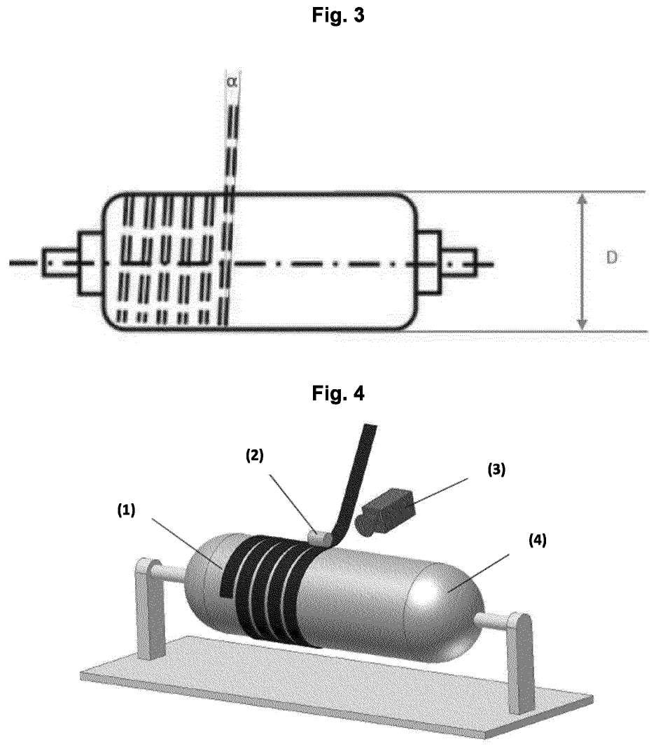

The rotor sleeve requires mainly resistance to circumferential stress. For this reason, the tapes are generally wound nearly perpendicular to the mandrel axis, that means with a winding angle approaching 90°. This type of circumferential winding is called “hoop winding”. In certain cases, cross-ply winding may be applied. Because long tubes are manufactured instead of rings the direction of the hoop lay-up is not purely at 90° but needs a slight angle to avoid the overlapping of the tapes. The angle to be applied depends on the width of the tape (typically ¼, ½ or 1 inch), and mandrel diameter as illustrated in FIG. 3. A compromise is generally found between mechanical performance as regards to the circumferential loads, which requires to minimize the fiber angle and therefore the tape width, and productivity with need to minimize the manufacturing cycle time using wider tapes. Furthermore, in case of assembly by press fitting, increased angle could help to increase the stability of the sleeve and prevent delamination.

The thickness of the rotor sleeve is a key factor, as performance and efficiency of the rotor are increased by reducing the air gap between the rotor and the stator. Therefore, thinnest sleeves (i.e. 0.5 to 2.0 mm) are preferred.

The tape used in both methods is typically an unidirectional tape.

Preparation of the tape: the tape of the thermoplastic composite (TPC) is prepared by known methods of impregnation of the continuous fibers by the polymer matric (P). The tape is generally prepared by the method comprising the following steps:
a)—bringing the continuous fibers, notably the continuous carbon fibers, in contact with the thermoplastic polymer of the polymeric matrix or the blend of the thermoplastic polymer(s) and/or the additive(s);
b)—heating the structure obtained in the previous step at a temperature sufficient to melt the polymer(s) of the polymer matrix.

During step a) and/or step b), pressure is generally applied on the structure.

When the polymer matrix (P) comprises the blend of thermoplastic polymers and/or at least one plastic additive, it is advantageous to make a blend of said ingredients prior to step a). This ensures an homogenous blend of these ingredients in the TPC. The blend may be prepared by blending powders or by melt mixing. Melt mixing is preferred as it ensures a more intimate blend of the thermoplastic polymer(s) and/or the plastic additive(s). Melt mixing can be carried out in a melt-mixing apparatus. Any melt-mixing apparatus known to the one skilled in the art can be used. A suitable melt-mixing apparatus may for example be selected in the list consisting of kneaders, Banbury mixers, single-screw extruders and twin-screw extruders. A convenient melt-mixing apparatus is a single-screw extruder or a twin-screw extruder. The polymer(s) and the plastic additive(s) (if any) may be introduced into the melt-mixing apparatus in any order. If step a) is performed via a slurry process, the blend prepared by the melt mixing process is ground to obtain the particles of the blend with the appropriate size.

For step a), various methods can be employed to bring the thermoplastic polymer or the blend into contact with the continuous fibers. The continuous fibers should be uniformly impregnated with the thermoplastic polymer or the blend. An homogeneous impregnation of all the fibers allows to make a tape with optimized mechanical properties.

Step a) may be performed by electrostatic powder coating, foam coating or by impregnation with the polymer(s) in solution or in a slurry (slurry process).

Slurry process: the slurry process is a convenient method to bring the continuous fibers into intimate contact with the polymer matrix (P). The slurry process is based on bringing the fibers into contact with a slurry of particles of the thermoplastic polymer or the blend suspended in a liquid phase. The slurry-impregnated fibers are then heated to a temperature sufficient to evaporate the slurry liquid and to melt the polymer(s) of the polymer matrix.

The size of the particles in the slurry should preferably be low enough to allow a better impregnation of the fibers. The grinding method is a convenient method to obtain these particles with the appropriate size. The liquid phase may be water, an organic liquid or a mixture of water and an organic liquid.

The median Dv50 (median determined on a distribution in volume) of the particles in the slurry is generally between 1 and 300 μm. Dv50 may be measured by laser scattering.

A surfactant may be present in the slurry. The term “surfactant” denotes any organic compound having a hydrophilic part and a lipophilic part, and capable of dispersing the particles in the liquid phase and of keeping it in suspension in the presence or in the absence of stirring.

The heating step may be performed at a first temperature sufficient to allow the evaporation of the slurry liquid and at a second temperature sufficient to melt the polymer(s) of the polymer matrix.

More information about the slurry process are provided for example, in U.S. Pat. No. 4,792,481, or in “Wet impregnation as route to unidirectional carbon fibre reinforced thermoplastic composites manufacturing”, Plastics Rubber and Composites, March 2011, Vol. 40 (2), p. 100-107 (DOI: 10.1179/174328911X12988622801098).

The slurry process disclosed in the experimental section may be used.

### PAEK Polymer(s)

A polyaryletherketone (PAEK) polymer denotes any polymer comprising more than 50.0 mol % of recurring units (R_{PAEK}) linked to one another by either the —O— or the —C(═O)— groups and selected from the group consisting of units of formulae (J-A) to (J-Q) below:

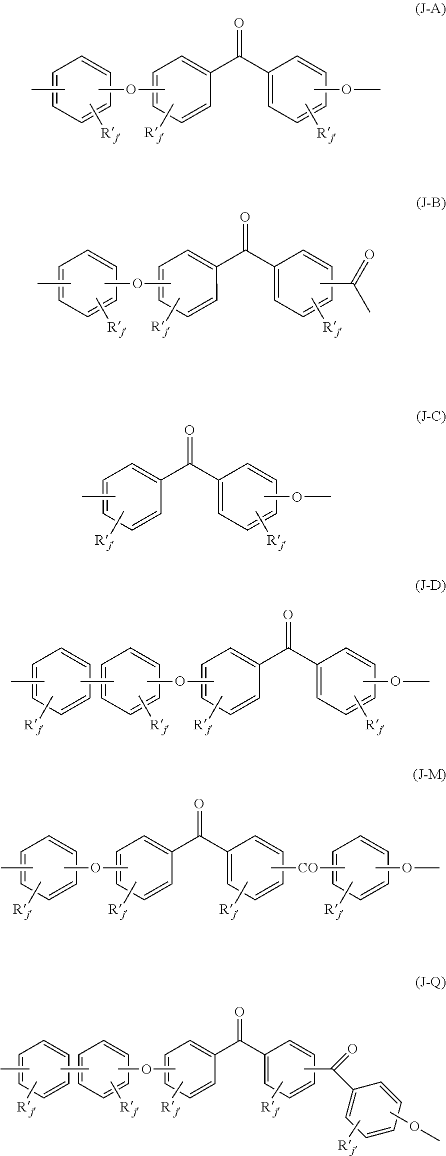

where:
   each R′ of R′ⱼ, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
   j′ is zero or an integer ranging from 1 to 4.

In recurring unit (R_{PAEK}), the respective phenylene moieties may independently have 1,2-, 1,4- or 1,3-linkages to the other moieties in the recurring unit (R_{PAEK}). Preferably, said phenylene moieties have 1,3- or 1,4-linkages.

j′ is preferably at each occurrence zero.

The proportion of recurring units (R_{PAEK}) in the PAEK is advantageously at least 60.0 mol %, or at least 70.0 mol %, or at least 80.0 mol %, or at least 90.0 mol %, or at least 95.0 mol %, or at least 99.0 mol %. According to an embodiment, all the recurring units of the PAEK polymer are recurring units (R_{PAEK}).

PEEK: as used herein, a “poly(ether ether ketone) (PEEK)” denotes any polymer of which more than 96.0 mol % of the recurring units are of formula (J′-A):

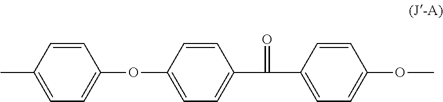

The proportion of recurring units (J′-A) in the PEEK may more particularly be at least 99.0 mol %. According to an embodiment, all of recurring units of the PEEK are recurring units (J′-A).

The melt flow rate of the PEEK as measured according to ASTM D1238 (400° C., 2.16 kg) may be between 1.0 and 50.0 g/10 min.

An example of PEEK that may conveniently be used is Ketaspire KT880 or KT820 commercialized by Solvay. Ketaspire KT880 UFP commercialized by Solvay may also be conveniently be used.

PEKK: as used herein, a “poly(ether ketone ketone) (PEKK)” denotes any polymer of which more than 95.0 mol % of the recurring units are a combination of recurring units of formula (J′-B) and formula (J″-B):

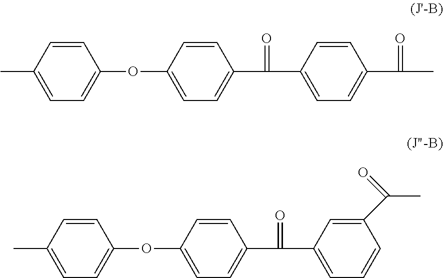

The proportion of recurring units (J′-B) and (J″-B) in the PEKK may more particularly be at least 99.0 mol %. According to an embodiment, all of recurring units of the PEKK are recurring units (J′-B) and (J″-B).

The molar ratio (J′-B)/(J″-B) is selected so that polymer is semi-crystalline. The molar ratio (J′-B)/(J″-B) is preferably greater than 60/40. The molar ratio (J′-B)/(J″-B) is preferably between 60/40 and 90/10 or between 65/35 and 80/20.

An example of PEKK that may be used is Kepstan 7002 commercialized by Arkema.

PEK: as used herein, a “poly(ether ketone) (PEK)” denotes any polymer of which more than 95.0 mol % of the recurring units are of formula (J′-C):

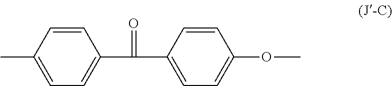

The proportion of recurring units (J′-C) in the PEK may more particularly be at least 99.0 mol %. According to an embodiment, all of recurring units of the PEK are recurring units (J′-C).

PEEKK: as used herein, a “poly(ether ether ketone ketone) (PEEKK)” denotes any polymer of which more than 95.0 mol % of the recurring units are of formula (J′-M):

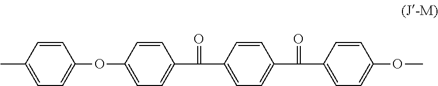

The proportion of recurring units (J′-M) in the PEEKK may more particularly be at least 99.0 mol %. According to an embodiment, all of recurring units of the PEEKK are recurring units (J′-M).

PEDEKK: a “PEDEKK” denotes any polymer of which more than 95.0 mol % of the recurring units (R_{PAEK}) are a combination of recurring units of formula (J′-Q) and (J″-Q):

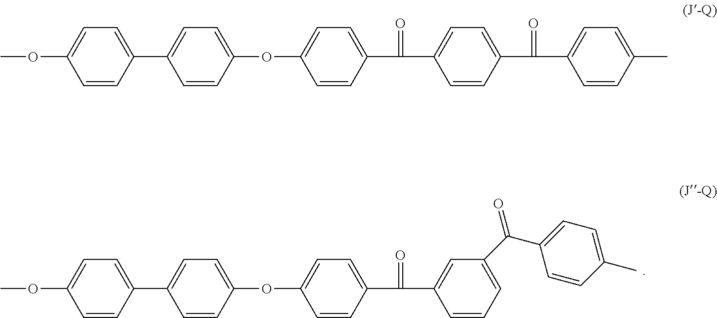

The proportion of recurring units (J′-Q) and (J″-Q) in the PEDEKK may more particularly be at least 99.0 mol %. According to an embodiment, all of recurring units of the PEDEKK are recurring units (J′-Q) and (J″-Q).

PEEK-PEDEK: a PEEK-PEDEK denotes any polymer if which more than 95.0 mol % of the recurring units are a combination of recurring units of formula (J′-A) and (J′-D):

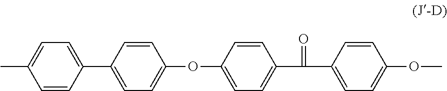

The proportion of recurring units (J′-A) and (J′-D) in the PEEK-PEDEK may more particularly be at least 99.0 mol %. According to an embodiment, all of recurring units of the PEEK-PEDEK are recurring units (J′-A) and (J′-D).

The molar ratio (J′-A)/(J′-D) may be between 95/5 and 60/40, or between 90/10 and 70/30.

PEEK-PEOEK: a PEEK-PEoEK denotes any polymer of which more than 95.0 mol % of the recurring units are a combination of recurring units of formula (J′-A) and (J″-A):

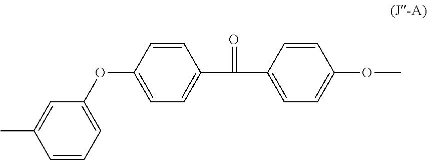

The molar ratio (J′-A)/(J″-A) may be between 95/5 and 5/95. This molar ratio may preferably be between 70/30 and 95/5.

All the PAEKs disclosed in this section are prepared by conventional polycondensation techniques well known in the art, notably by a nucleophilic route or by an electrophilic one. More precisely, the PAEKs may be prepared by a nucleophilic aromatic substitution in which a diaryl ether linkage is obtained. The polycondensation is generally conducted in a solvent, such as a diphenyl sulfone, at 300° C. or more, with the aid of a base such as Na₂CO₃ and/or K₂CO₃. Some details about the polycondensation involving the nucleophilic substitution may be found in e.g. U.S. Pat. No. 4,176,222 or WO 2021/008983. For instance, a PEEK is prepared by polycondensation of 4,4-difluorobenzophenone and hydroquinone by the nucleophilic route.

The PAEK polymer may be prepared by a Friedel-Crafts electrophilic substitution in which a diaryl ketone linkage is obtained. The polycondensation is generally conducted in a solvent at temperatures below 150° C. with the aid of a Lewis acid such as AlCl₃. Some details about the polycondensation involving the Friedel-Crafts electrophilic substitution may be found in e.g. U.S. Pat. Nos. 4,841,013, 4,816,556, WO 2011/004164 and WO 2014/013202. For instance, a PEKK may be prepared by polycondensation of 4,4-dichlorobenzene, iso and para-phthaloyl chloride by the electrophilic route.

### PPS Polymers

A polyphenylene sulfide (PPS) denotes any polymer comprising at least 50.0 mol. % of recurring units (R_{PPS}) of Formula (L):

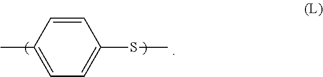

The proportion of the recurring units (L) may be at least 60.0 mol. %, or at least 70.0 mol. %, or at least 80.0 mol. %, or at least 90.0 mol. %, or at least 95.0 mol. %, or at least 99.0 mol. %.

According to an embodiment, all of the recurring units (R_{PPS}) in the PPS are recurring units of formula (L).

The PPS polymer is prepared by conventional polycondensation techniques well known in the art. More precisely, the PPS polymer may be heating a reaction mixture comprising at least one para dihalobenzene compound, such as para dichlorobenzene, a sulfur compound in a polar aprotic solvent. The sulfur compound is usually an alkali metal sulfide, such as Na₂S. In some embodiments, the alkali metal sulfide is generated in situ from an alkali metal hydrosulfide and an alkali metal hydroxide. Na2S can be generated in situ from NaSH and NaOH. The temperature at which the polymerization takes place is usually at least 150° C., more particularly at least 200° C.

The melt flow rate of the PPS as measured according to ASTM D1238 (316° C., 5 kg) may be between 1.0 and 50.0 g/10 min.

An example of PPS that may conveniently be used is Ryton QA200N commercialized by Solvay.

### Polyphthalamide (PPA) Polymers

A PPA polymer is any polyamide of which more than 55.0 mol %, preferably at least 75.0 mol %, preferably at least 99.0 mol %, of the recurring units (R_{PA}) are the result of the condensation of an aromatic phtalic acid selected in the group of terephthalic acid, isophthalic acid and a combination of said two phtalic acids and at least one diamine.

According to an embodiment, substantially all recurring units are recurring units (R_{PA}).

According to an embodiment, the recurring units of PPA consist of recurring units (R_{PA}).

The diamine may be aromatic or aliphatic.

The diamine is preferably an aliphatic diamine selected from the group consisting of 1,6-hexamethylenediamine, 1,9-nonanediamine, 1,10-diaminodecane, 2-methyloctanediamine, 2-methyl-1,5-pentanediamine or 1,4-diaminobutane. The diamine may more particularly be 1,6-hexamethylenediamine.

Polyamide (PPA) may more particularly be selected in the group consisting of the following polyamides: 6T/66; 6T/6I; 6T/6I/66; 6T/BACT/10T where BAC is 1,3-BAC and/or 1,4-BAC, preferably 1,3-BAC; polyamides with recurring units (RPA) formed the polycondensation of a monomer mixture consisting of T; 1,4-cyclohexanedicarboxylic acid; 1,6-diaminohexane and 1,10-diaminodecane; polyamides with recurring units (RPA) formed the polycondensation of a monomer mixture consisting of T; 1,4-cyclohexanedicarboxylic acid; 1,6-diaminohexane and 1,9-diaminononane and combination thereof.

An example of polyphthalamide that may conveniently be used is Amodel A-8004 commercialized by Solvay.

### PAI Polymers

A polyamide-imide (PAI) polymer is a polymer comprising more than 50.0 mol % of the recurring units (R_{PAI}) selected in the group consisting of:

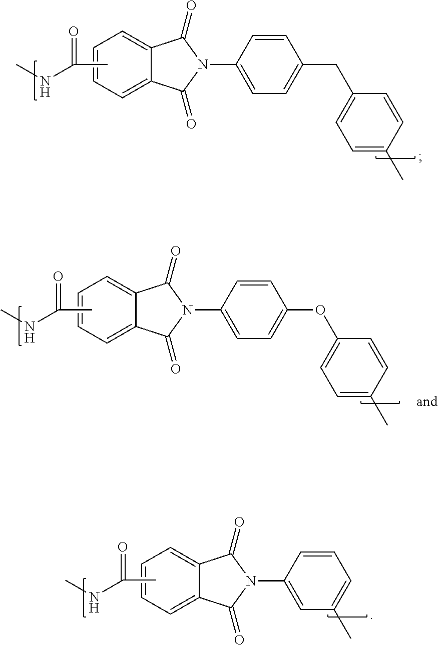

Most preferably, the polymer (PAI) comprises more than 90.0 mol % of the recurring units (R_{PAI}). Still more preferably, it contains no recurring unit other than recurring units (R_{PAI}).

An example of PAI polymer that may conveniently be used is Torlon 4203 L commercialized by Solvay.

### Plastic Additive(s)

The polymer matrix may also comprise at least one plastic additive.

The plastic additive(s) are generally blended with the thermoplastic polymer(s).

The plastic additive may be selected in the group consisting of colorants (e.g. dye and/or pigments), ultraviolet light stabilizers, heat stabilizers, antioxidants, acid scavengers, processing aids, internal lubricants and/or an external lubricants, flame retardants, smoke-suppressing agents, anti-static agents, anti-blocking agents and any combination thereof.

The proportion of the plastic additive(s) in the polymer matrix (P) is generally less than 20.0 wt %, this proportion being based on the total weight of the polymer matrix (P).

### Continuous Fibers

The thermoplastic composite (TPC) comprises continuous fibers as disclosed herein.

The thermoplastic composite (TPC) comprises the fibers, notably the continuous carbon fibers, substantially all of them being oriented at zero-degree fiber angle.

As used herein, the term “carbon fiber” is intended to include graphitized, partially graphitized and ungraphitized carbon fibers, as well as mixtures thereof. The carbon fibers can be obtained by heat treatment and pyrolysis of different polymer precursors such as, for example, rayon, polyacrylonitrile (PAN), aromatic polyamide or phenolic resin; carbon fibers may also be obtained from pitchy materials. The carbon fibers are preferably chosen from the group consisting of PAN-based carbon fibers, pitch based carbon fibers, graphite fibers and mixtures thereof. The graphitized fibers are typically obtained by a high temperature pyrolysis (generally over 2000° C.) of carbon fibers, wherein the carbon atoms place in a way similar to the graphite structure.

The continuous fibers typically exhibit an aspect ratio (ratio length/diameter) of greater than or equal to 500, more typically greater than or equal to 5000.

The continuous fibers are typically in the form of a tow (sometimes aka roving). A tow generally refers to a plurality of continuous individual filaments, optionally coated with an organic coating.

Carbon fiber tows are made of thousands of individual carbon fiber filaments that are bunched. Carbon fiber tows are available in many different sizes, commonly 3K, 6K, 12K, 24K or higher which refers to the number of thousands of filaments (3K tow is made of 3000 individual carbon filaments). In the context of the present invention, the size of the carbon fiber tow is preferably between 1K and 350K.

Carbon fiber tows with size lower than 14K allow to prepare a thin rotor sleeve. The size may thus be between 10K and 14K.

Carbon fiber tows with a size higher than 14K allow to wind the tape around the mandrel more quickly.

The tow of carbon fibers preferably exhibit a tensile strength greater than or equal to 3500 MPa and/or a tensile modulus greater than or equal to 200 GPa. The tensile strength may be greater than or equal to 5000 MPa. The tensile modulus may be greater than or equal to 250 GPa. It is also preferable that the carbon fibers are aligned, continuous carbon fibers. The tensile strength and tensile modulus can be measured according to ASTM D4018.

In the case of unidirectional tapes, as used herein, “tape” means a strip of material with longitudinally extending fibers that are aligned along a single axis of the strip material. Tapes may be manufactured with large width (from 50 mm up to 1 m or more) made of several tows judiciously spread and then slit in the form of narrow strips to be used for automated fiber placements. It is also possible to manufacture narrow ribbons made of a single tow with the advantage of not damaging the carbon fiber due to the slitting process. Tapes are advantageous because they can be used in hand or automated layup processes in order to create a composite material having relatively complex shape.

### Mechanical, Physical and Physico-Chemical Properties of the Unidirectional Tape of Thermoplastic Composite

The tape may also be defined by a combination of mechanical, physical/morphogical and physico-chemical properties. These properties are given for the tape that is used in the preparation of the rotor sleeve.

The tape usually exhibits a tensile strength (along 0 degree of fiber direction) of at least 2000 MPa. The tensile strength is preferably at least 2400 MPa, preferably at least 2700 MPa, preferably at least 2800 MPa. The tensile strength is measured according ASTM D3039. The tensile strength is usually at most 4500 MPa.

The unidirectional tape may also exhibit a tensile strain (along 0 degree of fiber direction) of at least 0.5%, preferably at least 1.0%, preferably at least 1.5%. The tensile strain is measured according ASTM D3039. The tensile strain is usually at most 5.0%.

The tape may also exhibit a tensile modulus (along 0 degree of fiber direction) of at least 100 GPa, preferably at least 150 GPa, preferably at least 170 GPa. The tensile modulus is measured according to ASTM D3039.

The tape may also exhibit a coefficient of thermal expansion measured along the direction of the fibers and according to ASTM E831 of at most 5.0 10⁻⁶ mm/mm/K, preferably at most 2.0 10⁻⁶ mm/mm/K, preferably at most 1.0 10⁻⁶ mm/mm/K. These values are notably given for a temperature between ambient temperature and 200° C.

The tape is also characterized by its morphology:

Thickness and thickness consistency: the thickness of the tape may be lower than or equal to 200 μm. This thickness may more particularly be lower than 120 μm.

Moreover, the variation of the thickness of the tape is preferably lower than and equal to 10.0%, preferably lower than and equal to 5.0%, the variation being defined as the standard deviation s of the thickness of the tape. s has the usual meaning in statistics and is defined by:

$$\\ s = √ \frac{\sum {( X - μ )}^{2}}{N} / μ \times 100$$

where X correspond to each value of the measurement of the thickness, μ is the arithmetic mean value and N the total number of measurements made. N is at least 10, preferably at least 20, preferably at least 50. The lower s, the better for the mechanical properties of the rotor sleeve.

Roughness Ra: the thermoplastic composite tape (TPC) preferably exhibits a surface roughness Ra lower than and equal to 10.0 μm. The surface roughness Ra is more particularly between 1.0 and 7.0 μm, preferably between 1.0 and 5.0 μm. The surface roughness Ra can be measured according to ISO 4288 & ISO 4287. The slurry process makes it possible to obtain such a low Ra. A low Ra enables a better processability and a better in situ consolidation.

Width: the width of the tape shall be done according to the lay-up process. The most common slit tape widths are ¼, ½, 1, 1¼, 1½ and 2 inches. Narrow tapes (i.e. ¼″) are generally chosen for 3D parts with small diameter, in certain cases to minimize the quantity of materials and associated material scraps/waste, or, in case of tape winding, to limit the angle of the hoop winding. Larger tapes are used to increase the production speed. In case of slit tape, some fibers are cut or damaged during the slitting increasing the width variation all along the tape.

Tow preg is another type of tape that can be used for the preparation of the rotor sleeve of the invention. Towpreg is a continuous composite tape made of one or two single tows of continuous carbon fibers. Each tow of the carbon fiber can have 12K, 24K, 36K or 50K filaments. The number of filaments in the tow preg is thus generally between 10K and 60K. For towpreg, it is important to maintain a constant square section all along the tapes. A tape or towpreg with low width variations will make the automated placement easier and more efficient (placement speed) avoiding presence of gaps or overlaps which reduce the performance of the composite part;

Porosity: during the preparation of the tape, air and volatiles can be entrapped in the material, leading to intraply porosity or voids which may affect the mechanical properties of the tape. The porosity of the tape is preferably lower than and equal to 2.0 vol %, preferably lower than and equal to 0.5 vol %, preferably lower than and equal to 0.2 vol %. The porosity is measured by microscopy analysis, which allows to visualize the shape and dimensions of the voids. Non-destructive inspection such as infra-red thermography and ultra-sonic inspection can also be applied.

### Properties of the Rotor Sleeve

The rotor sleeve of the invention preferably exhibits a hoop tensile strength (unnotched) measured according to ASTM D2290 (procedure B) of at least 2000 MPa, preferably at least 2100 MPa, preferably at least 2200 MPa, preferably at least 2300 MPa, preferably at least 2400 MPa.

Moreover, for embodiment (E), the thermoplastic composite preferably exhibits a crystallinity ratio Xc of at least 25.0%, Xc=[Hm in J/g]/[130 J/g]×100 where Hm is the heat of fusion of the thermoplastic composite of the sleeve expressed in J/g of PAEKs.

Hm is measured by DSC according to ASTM D3418 with the following thermal procedure: ramp-up from 40° C. to 380° C. at 10° C./min, cooling down until 40° C., second ramp up until 380° C. Hm is determined from the 1st ramp-up.

According to a preferred embodiment, the rotor sleeve of the invention is made of or comprises a thermoplastic composite (TPC) which comprises or consists of:
(1) a polymer matrix (P); and
(2) continuous carbon fibers,
   wherein the polymer matrix (P) comprises or consists of:
      at least one thermoplastic polymer selected in the group consisting of poly(ether ether ketone) (PEEK), poly(ether ketone ketone) (PEKK), poly(ether ketone) (PEK), poly(ether ether ketone ketone) (PEEKK), PEDEKK, PEEK-PEDEK, PEEK-PEOEK and blends of two or more of said polymers.
      optionally at least one plastic additive;
   and wherein:
      the rotor sleeve exhibits a hoop tensile strength (unnotched) measured according to ASTM D2290 (procedure B) of at least 2000 MPa, preferably at least 2100 MPa, preferably at least 2200 MPa, preferably at least 2300 MPa, preferably at least 2400 MPa; and/or
      the thermoplastic composite preferably exhibits a crystallinity ratio Xc of at least 25.0%, Xc=[Hm in J/g]/[130 J/g]×100 where Hm is the heat of fusion of the thermoplastic composite of the sleeve expressed in J/g of PAEKs and Hm is measured by DSC according to ASTM D3418 with the following thermal procedure: ramp-up from 40° C. to 380° C. at 10° C./min, cooling down until 40° C., second ramp up until 380° C., Hm being determined from the 1st ramp-up.

The thermoplastic polymer of the polymer matrix (P) typically exhibits a Tg of at least 140° C.

Xc is preferably at least 27.0%, preferably at least 28.0%, preferably at least 29.0%. Xc is generally lower than 50.0%, 130 J/g is taken as a reference value and corresponds to the heat of fusion of a totally crystalline polyetheretherketone.

All the details provided before apply equally to this preferred embodiment. In particular, the thermoplastic polymer may be a PEEK or a blend of at least one PEEK and at least one thermoplastic polymer other than the PEEK and selected in the group consisting of poly(ether ketone ketone) (PEKK), poly(ether ketone) (PEK), poly(ether ether ketone ketone) (PEEKK), PEDEKK, PEEK-PEDEK and PEEK-PEOEK.

### [Experimental Section]

Polymer used: Ketaspire KT880 UFP (Ultra-Fine Powder) from Solvay; its melt viscosity is 0.15 kPa-s at 1000/s at 400° C. (ASTM D3835). Dv50=10.5 μm.

### Continuous Carbon Fibers Used:

CF1: HexTow® IM7 from Hexcel. See https://www.hexcel.com/user_area/content_media/raw/IM7_HexTow_DataSheet.pdf. Tensile strength: 5688 MPa; weight length: 0.446 g/m; tow cross-sectional area: 0.25 mm²; filament diameter: 5.2 μm.

CF2: the other CF used have a 12K high strength standard modulus and exhibit a tensile strength of 5500 MPa, a tensile modulus of 250 GPa and a tensile strain of 2%. The filament diameter is 7 μm.

Both CF1 and CF2 are untwisted and untreated.

Process of preparation of the tape: the tapes were prepared using a slurry process. The tows of carbon fibers were fed from the creels. Spreading bars were used to convert the CF tows into ribbons and to shape them to a web before entering the slurry suspension bath. The slurry bath container is filled with an aqueous polymer slurry made by mixing Ketaspire KT-880 UFP and water. The web of CF picked up polymer powders in-between the fiber filaments and got coated by powders. After the web was guided out of the slurry bath, it went into the oven units and fuse rollers, so as to get water moisture eliminated and to get polymer impregnated onto the fiber. In the end, the TPC tapes were collected and wounded by the winder.

TABLE I
properties of the unidirectional tapes

| Ex. | 1 | 2 | 3 |
|---|---|---|---|
| Polymer matrix (P) | PEEK | PEEK | PEEK |
| Continuous fibers | CF1 | CF1 | CF2 |
| Fiber area weight | 156 | 154 | 183 |
| (g/m²) | | | |
| Proportion of | 34.5 | 41.0 | 32.7 |
| polymer in the | | | |
| polymer matrix (P) | | | |
| (wt. %) | | | |
| Proportion of CF in | 58.5 | 51.5 | 60.0 |
| the polymer matrix | | | |
| (P) (vol. %) | | | |
| Thickness (μm) | 168 | 183 | 169 |
| Roughness Ra (μm) | 4.5 | 5.0 | 4.0 |
| Porosity (%) | 1.6% | 1.1% | 1.9% |
| Tg [° C.] | 140.9° C. | 140.3° C. | 142.0° C. |
| Tm [° C.] | 344.7° C. | 344.9° C. | 345.3° C. |
| X_{c, tape}[%] | 14.3% | 12.9% | |

X_{c}=[H_{m, tape}/130 J/g]×100 where H_{m, tape} is the heat of fusion of the tape and expressed in J/g of resin.

Tg, Tm and Hm for the tapes were determined by a DSC analysis of the tape according to ASTM D3418. A full thermal cycle is performed which includes a first heating up to 400° C. at 10° C./min, a cooling down to 25° C. and a second heating up to 400° C. Hm is determined from the 1^{st} ramp-up.

Properties of the Consolidated Parts Made by Tape Winding with In-Situ Consolidation Using the Previously Defined Tapes 1-3

The rotor sleeves were prepared by tape winding with in-situ consolidation. The lay-up is a pure 8-layer hoop winding (90°). The ring is roughly 1 mm thick and has a 146 mm inner diameter. No trimming of the ring edges and no notch performed on the rings.

TABLE II

| Ex. | 1 | 2 | 3 |
|---|---|---|---|
| NOL strength | 2460 | 2210 | 2350 |
| results (ring) [MPa] | | | |
| according to ASTM | | | |
| D2290 | | | |
| SBS (short beam | 52 | 49 | / |
| shear strength) | | | |
| results (ring) [MPa] | | | |
| (1) | | | |
| X_{c, rotor sleeve} [%] (2) | 30.0% | 30.0% | / |

(1) SBS specimens were extracted parallelly to the winding direction from tube wound with a small angle of +/−89°, using ¼″ width slit tape. The tube thickness is around 4.5 mm (depending of the example), 146 mm inner diameter. The specimens respect ASTM D2344 dimensions. The set-up defined in ASTM D2344 for curved specimens was used, including flat support with a span length of 12 mm and a loading nose of 10 mm diameter (instead of 6 mm as defined in the standard).
(2) Crystallinity Hm for the sleeves was measured by DSC according to ASTM D3418 with the following thermal procedure: ramp-up from 40° C. to 380° C. at 10° C./min, cooling down until 40° C., second ramp up until 380° C. X_{c}=[H_{m, sleeve}/130 J/g]×100 where Hm, sleeve is the heat of fusion of the TPC of the sleeve and expressed in J/g of resin. Hm is determined from the 1^{st} ramp-up.

1. A rotor sleeve comprising a thermoplastic composite (TPC) which comprises of:
(1) a polymer matrix (P); and
(2) continuous fibers;
wherein the polymer matrix (P) comprises:
at least one thermoplastic polymer selected from the group consisting of poly(ether ether ketone) (PEEK), poly(ether ketone ketone) (PEKK), poly(ether ketone) (PEK), poly(ether ether ketone ketone) (PEEKK), PEDEKK, PEEK-PEDEK, PEEK-PEOEK and blends of two or more of said polymers and exhibits a Tg of at least 140° C.; and
optionally at least one plastic additive; and
wherein the continuous fibers are selected from the group consisting of:
continuous carbon fibers (CF), and
continuous glass fibers (GF).

2. (canceled)

3. (canceled)

4. The rotor sleeve according to claim 1, wherein:
a proportion of the continuous carbon fibers in the thermoplastic composite (TPC) is between 30.0 and 80.0 wt. %, this proportion being based on a total weight of the thermoplastic composite (TPC); and/or
a proportion of the polymer matrix (P) in the thermoplastic composite (TPC) is between 20.0 and 70.0 wt. %, this proportion being based on the total weight of the thermoplastic composite (TPC); and/or
a proportion of fibers is at least 130.0 g/m².

5. The rotor sleeve according to claim 1, wherein the thermoplastic polymer or the blend of thermoplastic polymers exhibits a heat of fusion (ΔH_{f}) which is at least 5.0 J/g and/or a melting temperature (Tm) of at least 250° C.

6. (canceled)

7. (canceled)

8. (canceled)

9. (canceled)

10. The rotor sleeve according to claim 1, wherein:
the PEEK is a polymer of which more than 96.0 mol % of the recurring units are of formula (J′-A): 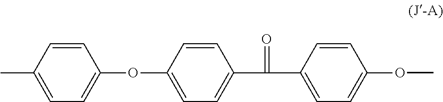
the PEKK is a polymer of which more than 95.0 mol % of the recurring units are a combination of recurring units of formula (J′-B) and formula (J″-B): 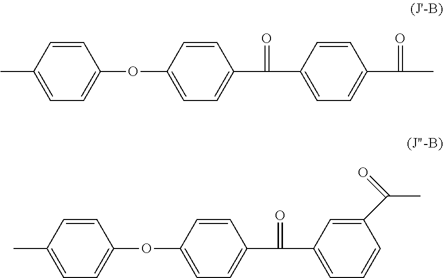
the PEK is a polymer of which more than 95.0 mol % of the recurring units are of formula (J′-C): 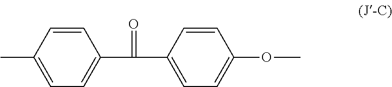
the PEEKK is a polymer of which more than 95.0 mol % of the recurring units are of formula (J′-M): 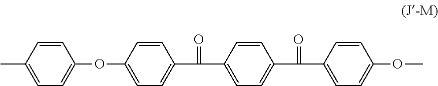
the PEDEKK is a polymer of which more than 95.0 mol % of the recurring units (R_{PAEK}) are a combination of recurring units of formula (J′-Q) and (J″-Q): 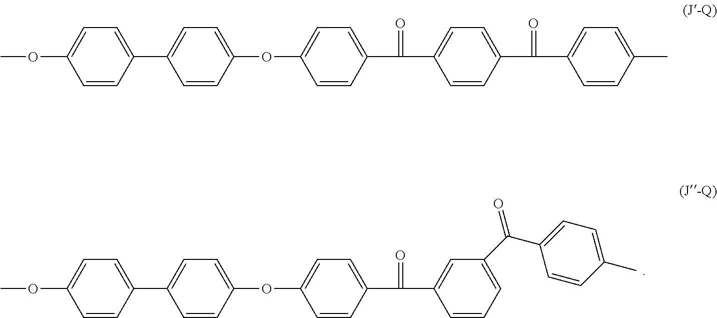
the PEEK-PEDEK is a polymer for which more than 95.0 mol % of the recurring units are a combination of recurring units of formula (J′-A) and (J′-D): 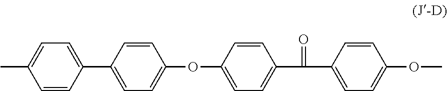
and
the PEEK-PEoEK is a polymer of which more than 95.0 mol % of the recurring units are a combination of recurring units of formula (J′-A) and (J″-A):

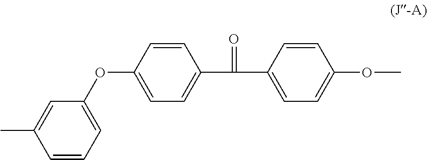

11. (canceled)

12. The rotor sleeve according to claim 1, exhibiting a hoop tensile strength (unnotched) measured according to ASTM D2290 (procedure B) of at least 2000 MPa.

13. The rotor sleeve according to claim 1, wherein the thermoplastic composite (TPC) exhibits a crystallinity ratio Xc of at least 25.0%,
where Xc is defined by the following formula:
$$\\ Xc = [ Hm in J / g ] / [ 130 J / g ] \times 100$$
where Hm is the heat of fusion of the thermoplastic composite expressed in J/g of PAEKs and measured by DSC according to ASTM D3418 with the following thermal procedure: ramp-up from 40° C. to 380° C. at 10° C./min, cooling down until 40° C., second ramp up until 380° C., Hm being determined from the 1^{st} ramp-up.

14. The rotor sleeve according to claim 1, wherein the continuous carbon fibers exhibit a tensile strength greater than or equal to 3500 MPa and/or a tensile modulus greater than or equal to 200 GPa.

15. (canceled)

16. (canceled)

17. The rotor sleeve according to claim 1, wherein a size of the carbon fiber tow is between 1K and 350K.

18. (canceled)

19. (canceled)

20. A method (M1) of preparation of the rotor sleeve as defined in claim 1, the method comprising the following steps:
step a): winding an unidirectional tape of a thermoplastic composite (TPC) over a rotating mandrel to form a plurality of layers of the thermoplastic composite (TPC) around the mandrel;
step b): separating the formed rotor-sleeve from the mandrel.

21. A method (M2) of preparation of the rotor sleeve as defined in claim 1, the method comprising the step of winding an unidirectional tape of the thermoplastic composite over the rotor to form a plurality of layers of the thermoplastic composite (TPC) around the rotor.

22. (canceled)

23. (canceled)

24. (canceled)

25. (canceled)

26. (canceled)

27. (canceled)

28. An electrical machine including:
a stator; and
a rotor disposed within the stator and configured to rotate relative to the stator;
wherein the rotor sleeve as defined in claim 1 is disposed circumferentially around the rotor.

29. A rotor of an electrical machine, wherein the rotor sleeve as defined in claim 1 is disposed circumferentially around the rotor.

30. (canceled)

31. The rotor sleeve of claim 1, wherein the thermoplastic composite (TPC) is a tape in the form of a tow preg or a slit tape.

32. (canceled)

33. The rotor sleeve according to claim 4, wherein the proportion of fibers is between 130.0 and 160.0 g/m².

34. The rotor sleeve according to claim 5, wherein the thermoplastic polymer or the blend of thermoplastic polymers exhibits a heat of fusion (ΔH_{f}) which is at least 10.0 J/g.

35. The rotor sleeve according to claim 12, wherein the hoop tensile strength (unnotched) measured according to ASTM D2290 (procedure B) is at least 2300 MPa.

36. The rotor sleeve according to claim 13, wherein the crystallinity ratio Xc is at least 28.0%.

37. The rotor sleeve according to claim 17, wherein the size of the carbon fiber tow is 3 K.

38. The rotor sleeve according to claim 17, wherein the size of the carbon fiber tow is 12 K.

39. The electrical machine of claim 28, wherein the electrical machine is a motor or a generator.
